(19) United States
(12) Patent Application Publication
(10) Pub. No.: US 2014/0360930 A1
(43) Pub. Date: Dec. 11, 2014

(54) DRY FORMED FILTERS AND METHODS OF MAKING THE SAME

(71) Applicants: Robert L. Tinkham, Appleton, WI (US); Robert Menzies, Waupaca, WI (US)

(72) Inventors: Robert L. Tinkham, Appleton, WI (US); Robert Menzies, Waupaca, WI (US)

(73) Assignee: GUSMER ENTERPRISES INC., Waupaca, WI (US)

(21) Appl. No.: 14/271,271

(22) Filed: May 6, 2014

Related U.S. Application Data
(60) Provisional application No. 61/981,663, filed on Apr. 18, 2014.
(60) Provisional application No. 61/831,769, filed on Jun. 6, 2013.

(51) Int. Cl. B01D 39/02

(52) U.S. Cl. CPC B01D 39/02
USPC 210/490

(57) ABSTRACT

The disclosure includes, in some embodiments, a filter element that includes a first porous outer layer formed from a nonwoven material, a second porous outer layer formed from a nonwoven material, and at least one inner porous layer formed from a high loft nonwoven material (or other suitable material) disposed between the first porous outer layer and the second porous outer layer. The high loft nonwoven material has a three dimensional matrix formed by entangled and bonded fibers that cooperate to form a plurality of three dimensional interstices between the fibers for maintaining an open and tortuous flow path for fluid to pass through. The filter element also includes filter aid particles dispersed in the interstices of the high loft nonwoven material.

### CROSS-REFERENCE TO RELATED APPLICATIONS

This patent application claims the benefit of priority to U.S. Provisional Patent Application Ser. No. 61/981,663, filed Apr. 18, 2014 and U.S. Provisional Patent Application Ser. No. 61/831,769, filed Jun. 6, 2013. U.S. Provisional Patent Application Serial No. 61/981,663, filed Apr. 18, 2014 is incorporated by reference herein in its entirety.

### COPYRIGHT NOTICE

A portion of the disclosure of this patent document contains material which is subject to copyright protection. The copyright owner has no objection to the reproduction by anyone of the patent document or patent disclosure as it appears in the Patent and Trademark Office, patent file or records, but otherwise reserves all copyrights whatsoever.

### BACKGROUND

1. Field

The present invention relates to filters and methods of making filters.

2. Description of Related Art

Conventional wet laid depth filter media utilizes a combination of wet slurried and refined fibers, filter aids and/or adsorbents, and wet strength resins to form in a vacuum-formed wet sheet. The formed sheet is oven-dried to remove residual moisture, crosslink the wet strength resin and yield an integral, mineral-filled sheet. The method of formation of these filters requires high amounts of water, utilization of significant electrical and energy resources for dewatering and drying, and large production equipment footprints. This method of formation does not lend itself to flexible manufacturing such as easy material changeovers or thorough cleanups between dissimilar materials. Besides filter sheets, filter aids or adsorbents in cake form such as precoats or body feeds are used for filtration purposes. The cakes are formed through slurrying of the filter aids and building of the cake by retaining the filter aids on a septum or substrate. The present disclosure provides solutions for these and other problems, as described herein.

### SUMMARY OF THE DISCLOSURE

The purpose and advantages of embodiments of the present disclosure will be set forth in, and be apparent from, the description that follows, as well as will be learned by practice of the disclosed embodiments. Additional advantages of embodiments of the disclosure will be realized and attained by the methods and systems particularly pointed out in the written description and claims hereof, as well as from the appended drawings.

To achieve these and other advantages and in accordance with the purpose of the disclosed embodiments, as embodied and broadly described, in accordance with one embodiment, the disclosure includes a filter element that includes a first porous outer layer formed from a nonwoven material, a second porous outer layer formed from a nonwoven material, at least one inner porous layer formed from a high loft nonwoven material disposed between the first porous outer layer and the second porous outer layer. The high loft nonwoven material has a three dimensional matrix formed by entangled and bonded fibers that cooperate to form a plurality of three dimensional interstices between the fibers for maintaining an open and tortuous flow path for fluid to pass through. The filter element also includes filter aid particles dispersed in the interstices of the high loft nonwoven material. The first porous outer layer, second porous outer layer and the at least one inner porous layer are bonded about a perimeter to define a compartment for containing the filter aid material within the interstices of the high loft nonwoven material. In accordance with one exemplary embodiment of a filter element, the first porous outer layer can have an inner surface and an outer surface. The at least one inner porous layer can have a first surface disposed along and in direct contact with the inner surface of the first outer layer. The second porous outer layer can have an inner surface disposed along and in direct contact with second surface of the at least one inner porous layer. In some implementations, the bond can be continuous about the perimeter of the compartment. If desired, the bond can include a series of bonded areas, or such as in a plurality of locations within the perimeter to help maintain uniformity of the powder within the pouch. The bond is preferably configured to confine the filter aid particles to provide even distribution of the filter aid particles. The first porous outer layer and/or the second porous outer layer can be formed from a polyester nonwoven material, such as a spun-bonded nonwoven material. The filter aid particles can include one or more of (i) a diatomaceous earth material, (ii) an adsorbent material, and (iii) a silicate material, such as magnesium silicate. If desired, the filter aid particles can form more than eighty percent of the weight of the filter element.

In further accordance with the disclosure, a lenticular filter stack is provided including a filter element as described herein, as well as a self-enclosed filter including a filter element as described herein. The disclosure also provides a capsule filter including a filter element as described herein, as well as a spun wound filter cartridge including a filter element as described herein. The disclosure also provides a pleated filter cartridge including a filter element as described herein. The pleated filter cartridge can be formed from a plurality of pleats. Each pleat can include one or more compartments for containing the filter aid material within the interstices of the high loft nonwoven material. In some embodiments, the pleats can be arranged into a cylindrical configuration surrounding and defining a cylindrical volume, and further wherein the pleats can be parallel to a central axis of the cartridge. The disclosure further provides an edible oil depth filter including a filter element as disclosed herein for filtering edible oil. The filter element, in turn can include one or more of (i) a filter aid and (ii) an adsorbent. For example, the filter element can include activated carbon. In a further embodiment, the filter element can include at least one blended filter aid composition.

In some embodiments, the at least one inner porous layer can include a high-loft multi-ply spunbond polyester nonwoven. The at least one inner porous layer can have a nominal thickness of 0.25 inches, for example. If desired, the filter element can include a series of layers of substrates and at least one of (i) a filter aid and (ii) an adsorbent. In further embodiments, the filter element can include a plurality of inner porous layers. Each of the inner porous layers can include at least one filter aid material.

The disclosure also provides a filter element. The filter element includes a first porous outer layer formed from a nonwoven material, second porous outer layer formed from a nonwoven material, at least one porous inner layer disposed between the first porous outer layer and the second porous outer layer. The at least one porous inner layer can have a three dimensional matrix formed by entangled fibers that cooperate to form a plurality of three dimensional interstices between the fibers to maintain an open and tortuous flow path through the filter element for fluid to traverse. The filter element also includes filter aid particles dispersed in the interstices of the at least one porous inner layer. The first porous outer layer and second porous outer can be bonded about a perimeter to define a compartment for containing the at least one porous inner layer and for containing the filter aid particles within the interstices of the at least one porous inner layer.

In some embodiments, the at least one porous inner layer can include loose fibers, which can in turn include natural and/or synthetic fibers. The at least one porous inner layer can include a layered spunbound composite material. The at least one porous inner layer can include one or more of a needlepunched web material, a hydroentangled web material, a felt material, a scrim material, and a netting material. If desired, the filter element can include at least one calcined metallic oxide. If desired, the filter element can include at least one blended filter aid composition.

In one embodiment, a liquid filter is provided including a filter element as described herein. The filter element of the liquid filter can include at least one of (i) a filter aid and (ii) an adsorbent. In some embodiments, the liquid filter includes activated carbon.

It is to be understood that both the foregoing general description and the following detailed description are exemplary and are intended to provide further explanation of the disclosed embodiments. The accompanying drawings, which are incorporated in and constitute part of this specification, are included to illustrate and provide a further understanding of the methods and systems and devices of the present disclosure. Together with the description, the drawings serve to explain the principles of the disclosed embodiments.

### BRIEF DESCRIPTION OF THE DRAWINGS

FIG. 1 is a schematic drawing of an illustrative filter element in accordance with the present disclosure.

FIG. 2 is schematic drawing of an illustrative filter element in accordance with the disclosure having a layered construction with joined areas to create filter zones.

FIG. 3 is a schematic drawing of a filter including a filter element in accordance with the present disclosure in spiral and pleated configuration.

FIG. 4 is a photomicrograph of an illustrative porous outer layer material for a filter element in accordance with the disclosure.

FIG. 5 is a photomicrograph of an illustrative inner layer material for a filter element in accordance with the disclosure.

FIG. 6 illustrates the inner layer material of FIG. 5 with a first filter aid deposited on it.

FIG. 7 illustrates the inner layer material of FIG. 5 with a second filter aid deposited on it different from that illustrated in FIG. 6.

### DETAILED DESCRIPTION OF PREFERRED EMBODIMENTS

Reference will now be made in detail to the present preferred embodiments of the disclosure, examples of which are illustrated in the accompanying drawings. The methods and corresponding steps of the disclosure will be described in conjunction with the detailed descriptions of the preferred embodiments.

In one aspect, the present disclosure is directed to more efficient and flexible filters and associated manufacturing methods for making the same that eliminate water usage for slurrying or refining, energy requirements for refining, vacuum formation and/ or sheet drying. Since the use of wet slurrying in water or other solvents can be eliminated, the technique can allow the use of water soluble filter aids or additives to assist in non-aqueous filtration cycles for contaminant removal. A further advantage is the resulting filter provides a useful format for additional processing such as device assembly including winding, pleating or insert injection molding. Still a further advantage is that the resulting filter article has similar properties and performance to conventional media for liquid applications. The resulting filter articles can be provided with a filter aid or blended filter aid composition, and can be provided in an easy-to-use format having attributes that are more desirable than filter cakes. Some implementations of the filter articles can be provided with suitable adsorbent chemistries or affinities with additional materials in an interior (e.g., middle) layer to allow for improved contact, porosity and less filter aid agglomeration. These combined layers, along with bonding or stitching of the layers, confine the interior materials, permitting relatively equal distribution of materials within a given surface area and less material migration or stratification in the product, resulting in consistent porosity and filtration performance.

In another aspect, the present disclosure is directed to filters for filtering waste materials from a fluid. In an exemplary embodiment, the filter is formed of an outer pocket that can be formed from two bonded substrate layers (such as a nonwoven material). The pocket, in turn, can then be provided with a filter material. The material for forming the substrate layers is selected depending on the choice of the filter material disposed between the layers, which may include a particulate material having a particular particle size distribution, and based on the desired composite porosity. The filter material preferably includes material that is sufficient to maintain an open flow path for the filtered fluid to pass through, and sufficient to provide adequate surface area and a suitably torturous path for the fluid to pass through to remove contaminants from the fluid. The substrate layers can be bonded together, such as by ultrasonic welding, stitching, adhesives via heat sealing or cold sealing, calendaring, and needlepunching, among other suitable techniques.

The disclosure similarly provides processes for producing a depth filter using dry formation methods for producing filter elements for use in filtration and adsorptive applications. The resulting filter element product includes a series of layers of substrates and filter aids and/or adsorbent materials to build depth, create porosity and provide a matrix to hold filter aids and/or adsorbent particles. Selection of the layers and particle aids can be determined by particle size distribution, balancing flow characteristics of the filter and the retention of the particles in the filter. Processing conditions and desired removal properties can also be factors in selecting materials for chemical affinity, compatibility and thermal stability. The finished depth filter product can be assembled using stitching, bonding or lamination methods to produce an integral depth filter product that can be used singly or in a layered filter construction, such as in sheet, stack, wound or pleated filter formats. Various embodiments of the depth filters described herein can be used as a flow-through filter.

Unlike conventional depth filters, various implementations of filter elements provided by the disclosure can accommodate high filter aid loadings without sacrifice of tensile strength. For example, it is typical for “wet laid” filters as described above to be limited to about 60-70% powder loadings by weight due to low strength and powder retention issues. In some implementations, the use of a high-loft nonwoven in the filter keeps the filter open enough to allow for a useful magnitude of flow through the filter. Using a nonwoven polymeric material facilitates the use of ultrasonic bonding techniques rather than sewing, which in turn removes the need for thread and provides a bond without puncturing the surface of the filter itself.

In view of the foregoing, illustrative embodiments herein, and aspects thereof, are described below.

Outer Substrates:

In accordance with the disclosure, a filter element is provided that includes a first porous outer layer formed from a nonwoven material, a second porous outer layer formed from a nonwoven material.

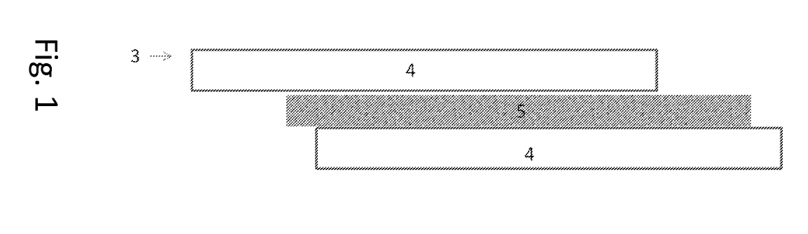

For purposes of illustration, and not limitation, FIG. 1 presents an exemplary layered construction of a filter element in accordance with the disclosure. As illustrated, the filter element includes first and second porous outer layers 4 that surround an inner layer 5 including one or more inner materials. As described herein, two outer substrate layers 4 are used in various embodiments to retain materials used in one or more inner layers 5. The selection of the outer layers can be made on the choice of materials disposed between the two outer substrate layers. For example, the particle size and particle distribution of any particulate material can be considered, as well as a desired composite porosity of the filter after assembly.

The outer substrate layers can include synthetic and/or natural materials, including but not limited to a polyester nonwoven material, such as a spunbond nonwoven material. Materials for the substrate layers can similarly include synthetic and/or natural materials, such as polyester, polypropylene, polyethylene terephthalate (“PET”), nylon, polyurethane, polybutylene terephthalate, polylactic acid, phenolic, acrylic, polyvinyl acetate, wood pulp, cotton, regenerated cellulose (i.e. rayon, lyocell), jute, grass fibers, glass fibers, and the like. These fibers can be formed into sheets or webs in various ways. For example, any desired nonwoven processes can be used (e.g., meltblowing, spunbonding, wet-laying, air-laying, needlepunching, electrospinning), as well as standard papermaking practices, similar to wet-laid nonwoven processes. In addition, the fibers can be woven using standard textile production techniques. Preferably, the outer substrate layers define pores therethrough that are small enough to substantially contain any powdered filter aid materials and the like.

Inner Materials:

Inner materials are disposed within the outer layers, and can include any suitable filter material, such as natural or synthetic materials such as loose fibers, filter aids, adsorbents or blends along with scrims, woven and nonwoven materials, such as layered spunbond composites, needlepunched webs, hydroentangled webs, layers of loose fibers, felts, netting, membranes, textiles, PET nonwoven material (preferably a high-loft PET nonwoven material) and the like to maintain an open flow path for the filtered fluid to pass through. If desired, the filter material can additionally or alternatively include one or more of silica or silicates, activated carbon, chitosan, diatomaceous earth, perlite, rhyolite, bauxite, zeolite, bentonite, glass beads, activated alumina, ion exchange resins/beads, superabsorbent polymer (SAP), crystalline and amorphous polymers, microcrystalline cellulose, nanocrystalline cellulose, food compatible acids (citric acid, tartaric acid, acetic acid, phosphoric acid, and malic acid), calcined metallic oxides (e.g., magnesium oxide, aluminum oxide, potassium oxide, calcium oxide, zinc oxide, ferric oxide), and granulated fruit peelings.

Bonding of Layers

The outer layers are bonded to each other (preferably through and to any interior layers) via any suitable bonding, stitching or adhesive techniques via heat sealing or cold sealing, calendaring, and needlepunching. The bonding results in the confinement of materials between the outer substrate layers, providing even, or substantially even distribution of any filter aids or absorbents per given surface area. The combined material layers may be bonded, die cut or formed in a variety of shapes or sizes and assembled into other final filtration devices.

Filtration Devices

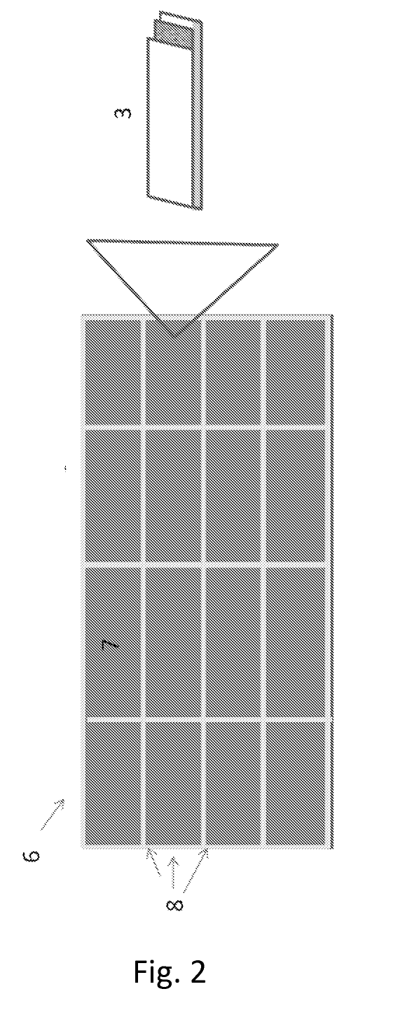

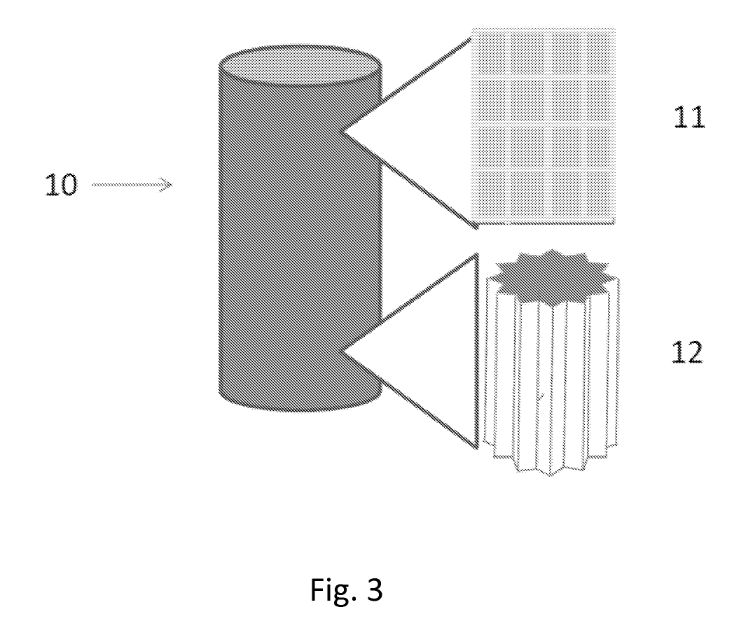

The filter elements can be used to assemble filtration devices, which in turn can include, but are not limited to, lenticular stacks, capsules, spun wound or pleated cartridges, or other enclosed self-contained filter designs. For purposes of illustration, FIG. 2 depicts a sandwiched construction 3 of outer layers 4 and inner layer 5 bonded along bond lines 8 to form filter zones 7 containing active filter aid materials. By way of further example, FIG. illustrates a enclosed filter device 10 incorporating the filter. A spiral wound configuration 11 is illustrated with the joined filter areas, as is a pleated filter configuration 12. These filtration designs offer improved filtration operations as compared to wet laid filters due to shorter set up or changeover times, improved operator safety as the high temperatures or harmful liquids to be filtered are generally not exposed to the operator or environment, and the final filter after use can easily be handled with minimal fluid losses, exposure to the operator, or handling a wet, dirty used filter.

### EXAMPLES

The following are illustrative examples of filter elements made in accordance with the disclosure, or aspects thereof. The following test methods were used in the Examples:

Caliper Testing: Samples were measured for thickness using an Emveco caliper gauge. Samples were measured within the bonded area in multiple locations, and an average of the measurements was recorded in mil.

Basis Weight Testing: After samples were formed, the entire pouch sample was weighed in grams on a scale capable of weighing to 0.001 g. The area of the pouch sample was measured and converted to square meters and the weight of the pouch was divided by the area. Basis weight was recorded in grams per square meter (gsm). A detailed description of the testing procedure is appended to U.S. Provisional Patent Application Ser. No. 61/981,663, filed Apr. 18, 2014.

Water Flow Rate Testing: A cake of filter aid sample was disposed on top of the nonwovens described in this example at a loading of approximately 0.190 lbs/ft² within a flow rate test apparatus. A fixed volume of water (1000 ml) was passed through the cake and the nonwoven layers at a set pressure of about 10 psi and the flow rate was determined by the amount of time it took to pass the volume of water through the pad. The temperature of the water used during the test was measured and the results were corrected to 70° F. by means of a temperature correction factor. Results are reported in gpm/ft² or Darcys. A detailed description of the testing procedure, specially modified to accommodate embodiments of the disclosure, is appended to U.S. Provisional Patent Application Ser. No. 61/981,663, filed Apr. 18, 2014.

Comparative Oil Filtration Testing: About 900 mL of used oil (obtained from local restaurants) was stirred on a stir plate for about 5 minutes to ensure homogeneity of the sample. The oil was then split into three approximately equal samples to be used for testing; one sample as a control and the other two samples for recirculation testing. One of the oil samples was directed through a wet laid filter sample and the other oil sample was directed through a dry formed filter in accordance with the present disclosure. All samples were heated to 148° C. and were stirred at 250 rpm. To form the nonwoven sample, the base nonwoven layer (outer substrate layer) was placed in the sample holder followed by a layer of high-loft nonwoven material described elsewhere in this example. The active material was then added followed by the top layer of outer substrate nonwoven material. The heated oil was than recirculated through the filter samples at about 15 ml/minute for 30 minutes before collecting approximately 100 ml of filtered oil for testing.

Free Fatty Acid (“FFA”) Removal: Filtered oil was tested against control oil utilizing the titration method outlined in A.O.C.S. Official Method No. CA5a-40 (appended to U.S. Provisional Patent Application Ser. No. 61/981,663, filed Apr. 18, 2014). The results obtained were expressed in terms of percent of oleic acid in the oil. The percentage of free fatty acids removed was calculated from the amount of oleic acid in the control oil sample compared to the amount in the filtered oil samples.

Soap Testing: Filtered oil and the control oil were tested for soaps utilizing a Foodlab fat cdR analyzer (user manual appended to U.S. Provisional Patent Application Ser. No. 61/981,663, filed Apr. 18, 2014). The soap testing followed the procedure outlined in the cdR FOODLAB fat Analysis methods booklet on page 12 (appended to U.S. Provisional Patent Application Ser. No. 61/981,663, filed Apr. 18, 2014). Results were recorded in parts per million.

Color Testing: Filtered oil and the control oil had a color analysis performed on them utilizing a HACH DR 4000U Spectrophotometer (user manual appended to U.S. Provisional Patent Application Ser. No. 61/981,663, filed Apr. 18, 2014). A blank cuvette was used as the baseline for testing and all samples were scanned across a range of wavelengths. Absorbance readings were recorded at wavelengths of 460 nm, 550 nm, 620 nm, and 670 nm. The photometric index was then calculated based on the absorbance values at these wavelengths. Percent color change was calculated using the formula:

((PI_{control}−PIₛₐₘₚₗₑ)/PI_{control})×100. (1)

A detailed description of the testing procedure (AOCS Official Method Cc 13c-50) is appended to U.S. Provisional Patent Application Ser. No. 61/981,663, filed Apr.18, 2014.

Filter Life and Efficiency Testing: A mixed model stream challenge of combined Ink and 0-3 micron Test Dust provided a turbidity of 125 NTU, as measured on a Hach 2100N Turbidimeter (user manual appended to U.S. Provisional Patent Application Ser. No. 61/981,663, filed Apr. 18, 2014). The challenge stream was passed through a 2 inch diameter filter sample at a flow rate of 1.0 gpm/ft², and turbidity, pressure and time were recorded until a differential pressure of +10 psi was reached. Throughout the test the filtrate was collected and a composite turbidity was determined. The percent retention was calculated using the following formula:

((initial turbidity−composite turbidity)/initial turbidity)*100.

### Example 1: Edible Oil Depth Filter

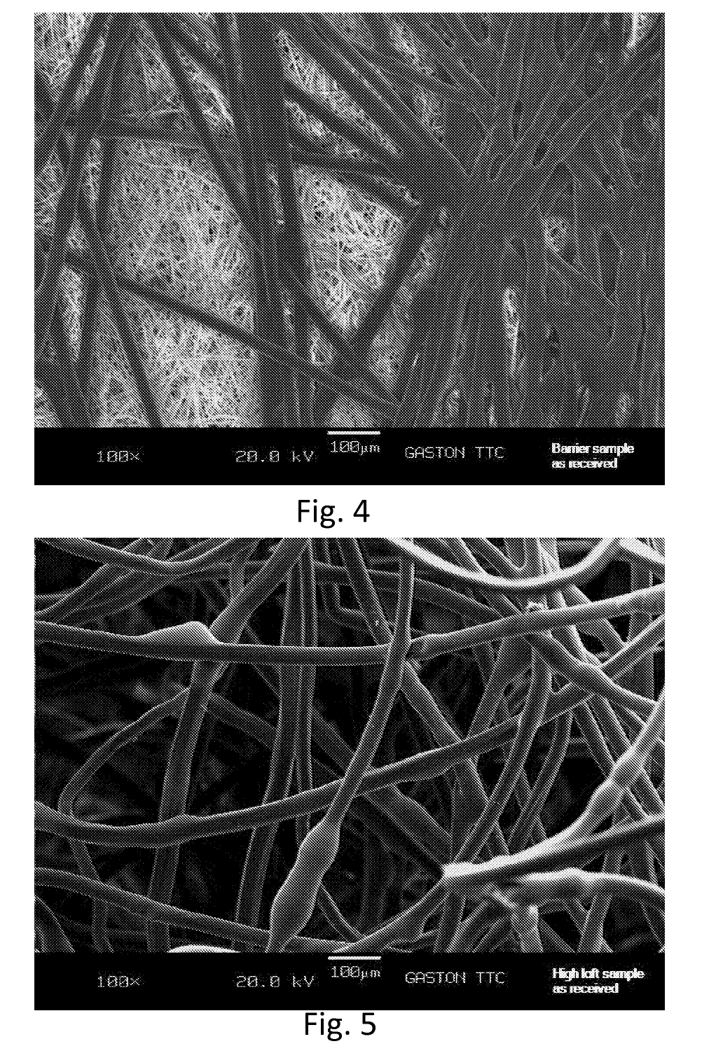

The outer layers of the filter were formed from a polyester spunbond meltblown spunbond (SMS) nonwoven web material (Product No. FM-200 obtained from Midwest Filtration, Cincinnati, Ohio, data sheet appended to U.S. Provisional Patent Application Ser. No. 61/981,663, filed Apr. 18, 2014) having a nominal thickness of 7 mil, a basis weight of 1.80 oz/yd², and an air permeability of 50 cfm/ft². A photomicrograph at 100× of this material is appended hereto in FIG. 4. This material has a sufficiently small pore size to substantially contain the active ingredient used. The inner layer disposed between the outer layers was a high-loft multi-ply spunbond polyester nonwoven material (Uniloft 675, also obtained from Midwest Filtration, Cincinnati, Ohio, data sheet appended to U.S. Provisional Patent Application Ser. No. 61/981,663, filed Apr. 18, 2014) with a nominal thickness of 0.25 inches, a basis weight of 6.75 oz/yd², and an air permeability of 800 cfm/ft². This illustrative high-loft nonwoven was used to provide depth in the resulting filter element and maintain a high enough flow rate to allow fluid to pass through the filter element at a reasonable rate. The active filter aid (synthetic magnesium silicate) was dispersed in the nonwoven composite. The purpose of the magnesium silicate is to lower the contaminants in the used oil (e.g., free fatty acids, polars, and soaps) while also altering the color back to near its original color.

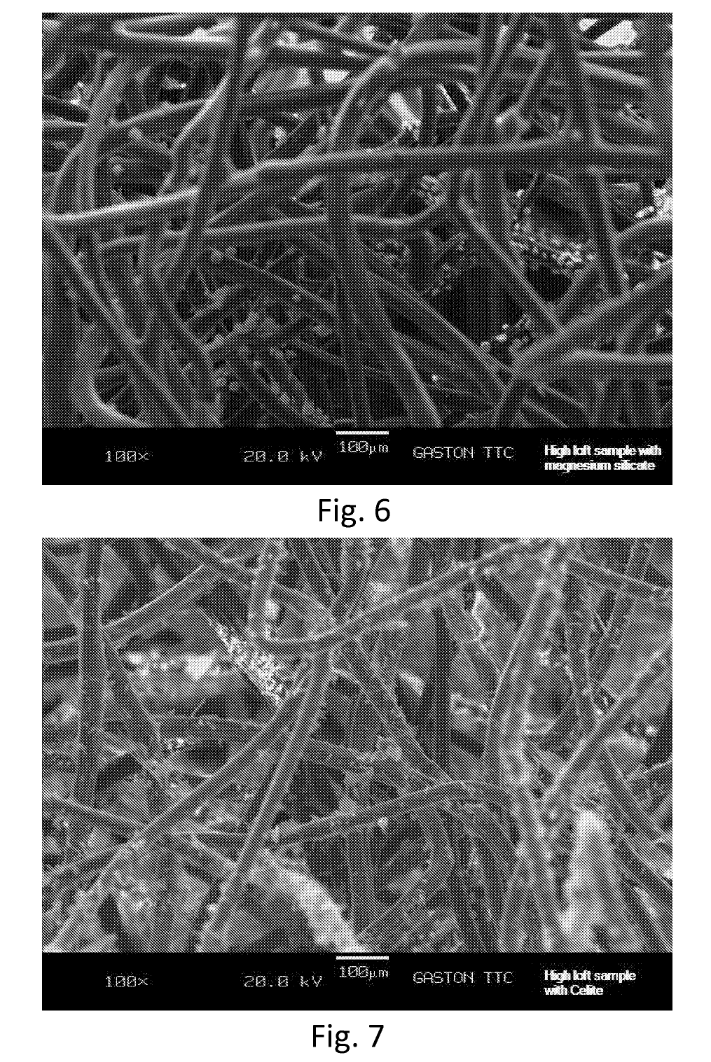

Ultrasonic bonding was used to join the outer layers to each other through the inner nonwoven layer. These lab-scale samples were bonded using a SeamMaster SM86 ultrasonic bonder (from Sonobond Ultrasonics, West Chester, Pa.; user manual appended to U.S. Provisional Patent Application Ser. No. 61/981,663, filed Apr. 18, 2014). To assemble the stack, a first outer layer and the center high-loft polyester layer were first laid down. The magnesium silicate powder was then deposited onto the highloft polyester layer to provide a loading of about 0.190 lbs/ft². The top outer layer was then laid on top of the high loft nonwoven layer containing the particulate, and the resulting stack was then bonded together ultrasonically. Bonds were formed along all four outside edges of the stack, resulting in a pouch containing active material dispersed within interstices of the high loft nonwoven. Photomicrographs of the nonwoven material without and with magnesium silicate dispersed therein is presented in FIGS. 5 and 6, respectively. While additional bonds could have been formed within the boundaries of the initial bonds in order to maintain some uniformity of the powder within the pouch, this was not performed in this test. Control settings of the ultrasonic bonder mentioned above used to form a suitable bond were as follows: Output-2, Speed A-1, Speed B-1. Prior to sealing the edges, equipment was set to ensure that the pattern wheel just came into contact with the horn.

Initial flow testing as described above yielded results of 86.12 gpm/ft² which is equivalent to 5.35 Darcys. Basis weight of the pouch was measured at 1129 gsm, and the thickness was determined to be 291.2 mil.

Comparative performance testing was conducted after recirculating used edible oil through the pouch filter sample as described above, along with a filter control pad, as described in U.S. Provisional Patent Application Ser. No. 61/981,663, filed Apr. 18, 2014. Test methods for oil performance included free fatty acid analysis, soap and color analysis. The pouch filter sample removed 12.21% of free fatty acids from the oil, while giving a color change of 69.90%, and reducing the soap content from 18 ppm to <1 ppm. The control sample removed 10.07% of free fatty acids from the oil, while giving a color change of 67.80%, and reducing the soap content from 18 ppm to <1 ppm.

### Example 2: Edible Oil Pad with >80% Powder Loading

The components used in this Example 2 are the same components as used in Example 1 above. Prior to assembling the stack of materials, each of the nonwoven layers was cut to a size of 5 inches by 8 inches. The samples were then marked 0.25 inches from all edges to denote where the welds would occur. The samples were then weighed. Based on the dimensions of the nonwovens, within the denoted marks for the welds, the amount of powder needed to provide a loading of 0.377 lbs/ft² was calculated. The pad was then constructed as described in Example 1. The resulting powder loading of the sample was 0.325 lbs/ft². This construction produced a pad with 80.7% powder by weight. Initial flow testing yielded results of 52.92 gpm/ft² which is equivalent to 3.29 Darcys. Basis weight was measured at 1659 gsm, and thickness was determined to be 358.8 mil.

### Example 3: Liquid Depth Filter with Diatomaceous Earth

The nonwoven components of this Example 3 are the same as used in Example 1 and Example 2 above. The preferred filter aid used in this example is a calcined diatomaceous earth, in this case, Celite® 577 filter aid (obtained from Imerys Filtration Materials, San Jose, Calif.). The filter aid provides additional surface area and provides depth to the filter to enhance the filtration properties of the filter. A depiction of this material deposited onto the high loft nonwoven material is provided in FIG. 7.

The nonwoven layers used in this Example were measured out to 6 in by 6 in and were marked for powder loading in the center 5 inch by 5 inch portion of the high loft nonwoven. The powder was then loaded in the pad to produce similar powder loading to current specifications of a Gusmer Enterprises produced filter sheet (Gusmer Enterprises Inc., Waupaca, Wis.). The nonwoven layers were than bonded along the markings at 5 inch by 5 inch to envelop the powder.

Initial flow testing yielded results of 9.25 gpm/ft² which is equivalent to 0.57 Darcys. Basis weight was measured at 1007 gsm, and thickness was determined to be 276.9 mil. Filter life and efficiency testing resulted in filter life of 17 minutes and a composite pool turbidity of 17 NTU. With a starting challenge turbidity of 125 NTU filter retention was 86.4%.

Any version of any component or method step of this disclosure may be used with any other component or method step of this disclosure. The elements described herein can be used in any combination whether explicitly described or not. All combinations of method steps as used herein can be performed in any order, unless otherwise specified or clearly implied to the contrary by the context in which the referenced combination is made. As used herein, the singular forms “a,” “an,” and “the” include plural referents unless the content clearly dictates otherwise. Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

The devices, methods, compounds and compositions of the present invention can comprise, consist of, or consist essentially of elements described herein, as well as any additional or optional steps, ingredients, components, or elements described herein or otherwise suitable. The methods and systems of the present invention, as described above and shown in the drawings, provide for systems and methods with superior attributes to those of the prior art. It will be apparent to those skilled in the art that various modifications and variations can be made in the devices and methods of the present disclosure without departing from the spirit or scope of the disclosure. Thus, it is intended that the present disclosure include modifications and variations that are within the scope of the subject disclosure and equivalents.

What is claimed is:

1. A filter element, comprising;
a) a first porous outer layer formed from a nonwoven material;
b) a second porous outer layer formed from a nonwoven material;
c) at least one porous inner layer disposed between the first porous outer layer and the second porous outer layer, the at least one porous inner layer having a three dimensional matrix formed by entangled fibers that cooperate to form a plurality of three dimensional interstices between the fibers to maintain an open and tortuous flow path through the filter element for fluid to traverse; and
d) filter aid particles dispersed in the interstices of the at least one porous inner layer, wherein the first porous outer layer and second porous outer are bonded about a perimeter to define a compartment for containing the at least one porous inner layer and for containing the filter aid particles within the interstices of the at least one porous inner layer.

2. The filter element of claim 1, wherein the at least one porous inner layer includes loose fibers.

3. The filter element of claim 2, wherein the loose fibers include natural fibers.

4. The filter element of claim 2, wherein the loose fibers include synthetic fibers.

5. The filter element of claim 1, wherein the at least one porous inner layer includes a layered spunbound composite material.

6. The filter element of claim 1, wherein the at least one porous inner layer includes a needlepunched web material.

7. The filter element of claim 1, wherein the at least one porous inner layer includes a hydroentangled web material.

8. The filter element of claim 1, wherein the at least one porous inner layer includes a felt material.

9. The filter element of claim 1, wherein the at least one porous inner layer includes a scrim material.

10. The filter element of claim 1, wherein the at least one porous inner layer includes netting material.

11. A liquid filter including a filter element according to claim 1 for filtering liquid.

12. The filter element of claim 1, wherein the filter element includes at least one calcined metallic oxide.

13. The filter element of claim 1, wherein the filter element includes at least one blended filter aid composition.

14. The liquid filter of claim 1, wherein the filter element includes at least one of (i) a filter aid and (ii) an adsorbent.

15. The liquid filter of claim 14, wherein the filter element includes activated carbon.
